(19) United States
(12) Patent Application Publication
(10) Pub. No.: US 2010/0279206 A1
(43) Pub. Date: Nov. 4, 2010

(54) Sealing structure of fuel cell separator

(75) Inventors: Jong Hyun Lee, Gyeonggi-do (KR); Jae Jun Ko, Gyeonggi-do (KR); Seung Chan Oh, Gyeonggi-do (KR); Young Min Kim, Gyeonggi-do (KR); Ik Jae Son, Gyeonggi-do (KR); Jong Jin Yoon, Seoul (KR); Young Bum Kum, Seoul (KR)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR)

(21) Appl. No.: 11/999,820

(22) Filed: Dec. 6, 2007

(30) Foreign Application Priority Data
Jun. 26, 2007 (KR) 10-2007-0062991

(51) Int. Cl. H01M 2/08

(52) U.S. Cl. 429/508

(57) ABSTRACT

The present invention provides a sealing structure of a sealing portion for maintaining the airtightness of a coolant passage in two stacked separators of a fuel cell, wherein a groove in which an adhesive is to be filled is formed on a surface of one of two separators, and dam portions are formed on both sides of the groove to prevent the adhesive applied in the groove from overflowing into a connection passage and a coolant passage. Accordingly, the adhesive overflowing from the groove when the two separators are bonded to each other by applying a pressure is collected in the dam portions to form three sealing lines, thus improving the airtightness of the sealing portion. Moreover, it is possible to solve the problem that the performance of the fuel cell stack is deteriorated when an antifreeze/coolant leaks from the coolant passage to an MEA, in which the fuel cell reaction takes place, or the leaking coolant contaminates a catalyst of the MEA.

### CROSS-REFERENCE TO RELATED APPLICATION

This application claims under 35 U.S.C. §119(a) on Korean Patent Application No. 10-2007-0062991, filed on Jun. 26, 2007, the entire contents of which are incorporated herein by reference.

### BACKGROUND

(a) Technical Field

The present invention relates to a sealing structure of a fuel cell separator. More particularly, the present invention relates to a sealing structure of a sealing portion for maintaining the airtightness of a coolant passage in a separator for a fuel cell stack.

(b) Background Art

As well known in the art, a fuel cell system is a power generation system that directly converts chemical energy of a fuel into electrical energy.

The fuel cell system comprises a fuel cell stack for generating electrical energy, a fuel supply system for supplying fuel (hydrogen) to the fuel cell stack, an air supply system for supplying oxygen in air, which is an oxidizer required for an electrochemical reaction, to the fuel cell stack, and a heat and water management system for removing the reaction heat of the fuel cell stack to the outside of the system and controlling the operation temperature of the fuel cell stack.

In the fuel cell system with the above configuration, electricity is generated by an electrochemical reaction between hydrogen as fuel and oxygen in air, and heat and water are produced as reaction by-products.

The fuel cell stack widely used for vehicles is a proton exchange membrane fuel cell (PEMFC), also known as a solid polymer electrolyte fuel cell (SPFC).

FIG. 1 is a schematic diagram illustrating the configuration of a fuel cell stack. The fuel cell stack comprises: a 3-layer membrane electrode assembly (MEA) 11 including an electrolyte membrane, through which hydrogen ions pass, and an electrode/catalyst layer, in which an electrochemical reaction occurs, attached on both sides of the electrolyte membrane; a gas diffusion layer (GDS) 12 for uniformly diffusing reactant gases and transmitting the electricity; a gasket and a sealing member for maintaining the airtightness of the reactant gases and a coolant and a proper bonding pressure; and a separator 10 through which the reactant gases and the coolant pass.

Meanwhile, in the solid polymer electrolyte fuel cell, hydrogen as fuel is supplied to an anode (so-called a fuel electrode) and oxygen in air is supplied to a cathode (so-called an air electrode or an oxygen electrode).

The hydrogen supplied to the anode is decomposed into protons H⁺ (hydrogen ions) and electrons e⁻ by a catalyst of the electrode/catalyst layer provided on both sides of the electrolyte membrane. At this time, only the hydrogen ions are transmitted to the cathode through the electrolyte membrane, which is a cation exchange membrane and, at the same time, the electrons are transmitted to the anode through the GDL 12 and the separator 10, which are conductors.

The hydrogen ions supplied through the electrolyte membrane and the electrons transmitted through the separator 10 meet the oxygen in air supplied by an air supplier at the anode and cause a reaction that produces water.

At this time, with the flow of electrons, generated by the movement of hydrogen ions, through an external conducting wire, a current is generated and, at the same time, heat is produced in the water production reaction.

The electrode reactions in the solid polymer electrolyte fuel cell can be represented by the following formulas:

Reaction in the fuel electrode:2H₂→4H⁺+4e⁻

Reaction in the air electrode:O₂+4H⁺+4e⁻→2H₂O

Overall reaction:2H₂+O₂→2H₂O+electrical energy+heat energy

Extensive research and development aimed at improving the performance of the solid polymer electrolyte fuel cell as described above have continued to progress.

Meanwhile, a groove for providing a cooling passage is formed on the separator, which is a component of the fuel cell stack, and two separators each having the groove are adhered to each other to form a structure for cooling the fuel cell. In this case, the grooves are formed on the surfaces facing each other of the two separators to form one coolant passage on the interface between the separators adhered to each other by a sealing member.

The coolant passes through the cooling passage formed by the two separators to cool the fuel cell.

A conventional sealing structure of a sealing portion in a separator is formed by thinly coating a room-temperature curing adhesive (trade name “Hylomer 623LV”) on one surface of the separator, on which a coolant passage of a hydrogen electrode plate or an air electrode plate is formed, or both surfaces thereof using a printing method such as silk screen, pressurizing the sealing the surfaces at a pressure of 1 bar, and curing the sealing portion at room temperature for 24 hours.

Recently, a method of using an antifreeze/coolant, instead of distilled water, as the coolant in the fuel cell stack, has been developed to solve a problem that the coolant is frozen at a temperature below the freezing point.

However, as a result of analyzing output characteristics and durability performance of a fuel cell stack manufactured using a cooling separator sealed by the conventional sealing structure, in which the antifreeze/coolant is used for the starting operation of a fuel cell vehicle at a low temperature below the freezing point, it can be confirmed that the output characteristics are deteriorated with the passage of time.

FIG. 2 is a graph showing the results of an antifreeze/coolant compatibility test, from which it can be seen that the performance of the fuel cell stack is deteriorated when the antifreeze/coolant is used in the prior art sealing structure.

As a result of the analysis, it is found that the adhesive used in the sealing portion of the cooling separator is not completely cured and minute air passages are formed by moisture (or organic solvent) evaporated during the curing process. Moreover, it is confirmed that a complete airtightness is not formed on the surface of the coolant passage since the sealing surfaces of the separators are not closely adhered to each other by the thickness of the adhesive applied between the hydrogen plate and the air plate. Furthermore, ethylene glycol of the antifreeze/coolant leaking therethrough may contaminate the catalyst in the electrode/catalyst layer of the MEA, thus deteriorating the performance of the fuel cell stack.

The information disclosed in this Background section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to solve the above problems, and an object of the present invention is to provide a sealing structure of a sealing portion for maintaining the airtightness of a coolant passage in a separator for a fuel cell stack that can solve the above-described problem associated with leakage of antifreeze/coolant from a coolant passage to an MEA and thereby improve output characteristics and durability of the fuel cell stack by minimizing the electrical resistance between the two separators.

In an aspect, the present invention provides a sealing structure of a sealing portion for maintaining the airtightness of a coolant passage formed in a first and a second separators stacked in a fuel cell, wherein a groove in which an adhesive is to be filled is formed on sealing portion of the first separator, dam portions are formed on both sides of the groove, one side of each of the dam portions being open toward the boundary surface between the first and second separators such that adhesive, which is to overflow from the groove when the first and second separators are pressurized to be bonded to each other, may be filled in the respective dam portions.

In a preferred embodiment, the dam portions are formed on the first separator, and one side of each of the dam portions is open toward the groove such that the inside space thereof is in communication with that of the groove.

In another preferred embodiment, the dam portions are formed on the first separator, and the dam portions are formed on the boundary surface between the first and second separators so as to be spaced apart from the groove at a predetermined interval such that the inside space thereof is separated from that of the groove.

In still another preferred embodiment, the dam portions are formed on the second separator, the dam portions are in communication with each other to form a space to accommodate adhesive, the width of the dam portions is greater than the width of the groove, a part of combined width of the dam portions overlaps the width of the groove, and the other part of the width is positioned on both sides of the groove.

In a further preferred embodiment, the dam portions are formed on the second separator, the dam portions are spaced apart from each other at a predetermined interval, a part of the width of each of the dam portions overlaps a part of the width of the groove, and the other part of the width is positioned on both sides of the groove.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

Other aspects of the invention are discussed infra.

### BRIEF DESCRIPTION OF THE DRAWINGS

FIG. 1 is a schematic diagram illustrating the configuration of a fuel cell stack;

FIG. 2 is a graph illustrating performance degradation occurring when an antifreeze/coolant is used in an existing sealing structure;

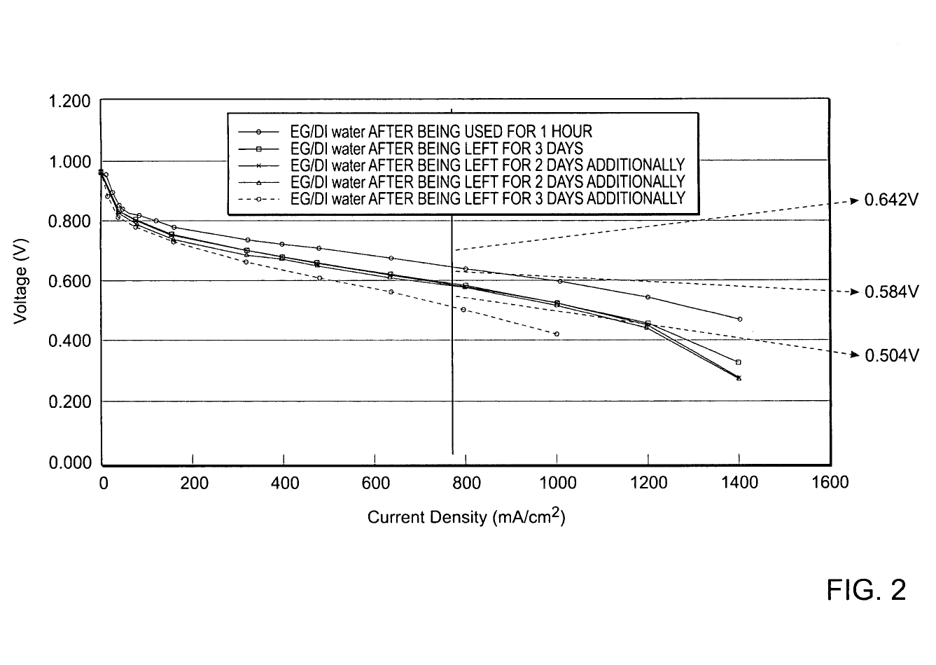

FIG. 3 is a graph illustrating electrical resistance losses in a fuel cell;

FIG. 4 is a cross-sectional view illustrating embodiments of a sealing structure of a fuel cell separator; and

FIG. 5 is a diagram illustrating the positions of a separator, an MEA and a GDL when being stacked.

Reference numerals set forth in the Drawings includes reference to the following elements as further discussed below:

| | |
|---|---|
| 113: separator | 114: groove |
| 114a and 114b: dam portions | |

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

A solid polymer electrolyte fuel cell has a theoretical voltage of 1.23 V and its performance and efficiency depends on electrical resistance losses according to the amount of load.

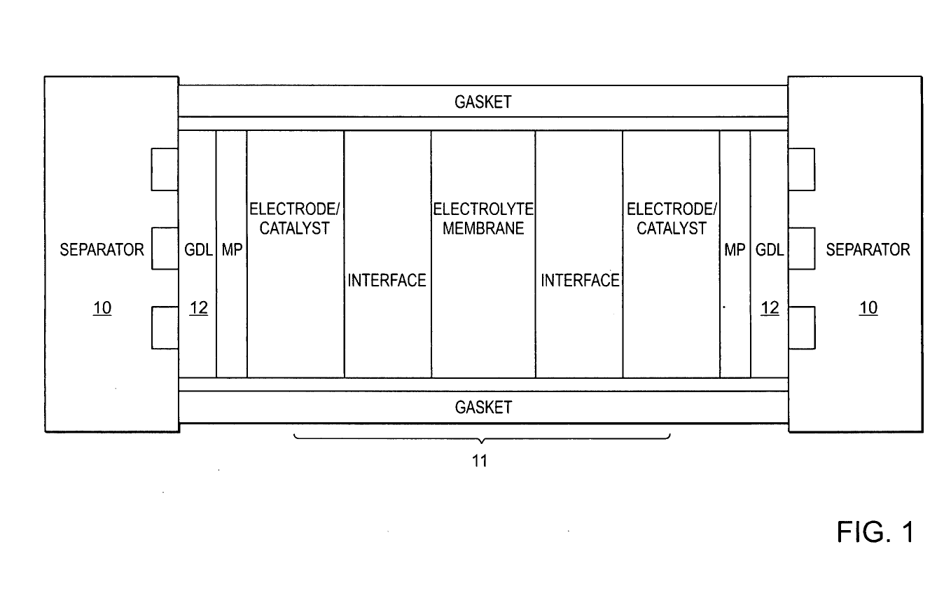

In particular, as shown in FIG. 1, when a fuel cell stack is composed of respective components stacked in a predetermined form, the components constituting each cell should be developed to minimize electrical resistance losses.

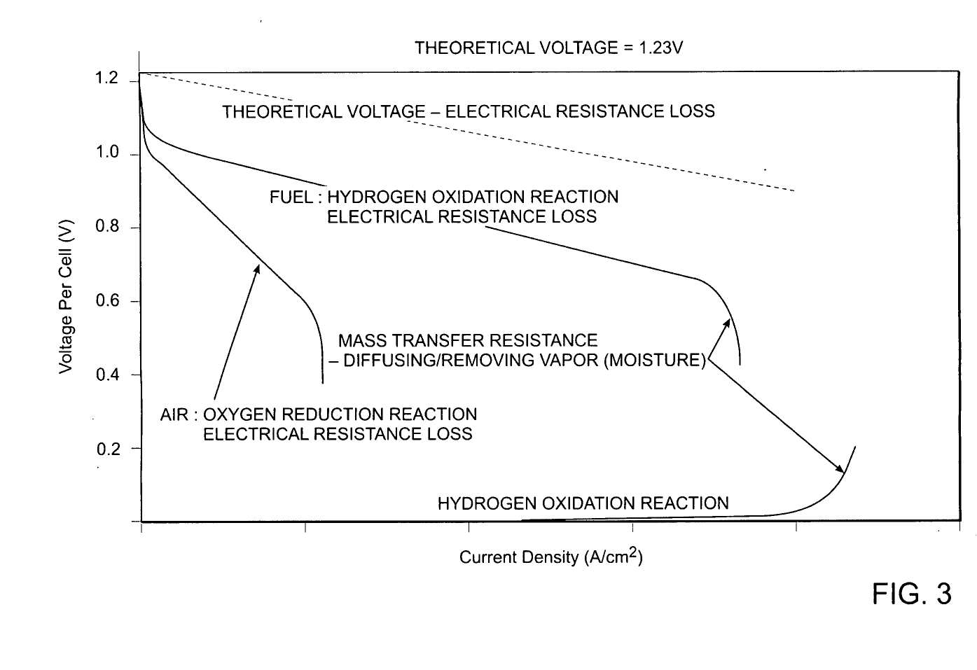

Moreover, the individual unit cells constituting the fuel cell stack should have sufficient sealing performance for maintaining the airtightness of reactant gases and coolant and, at the same time, have sufficient electrical contact with one another. Furthermore, as shown in FIG. 3, the performance and efficiency of the fuel cell may be improved when an oxygen reduction reaction, a hydrogen oxidation reaction and a mass transfer resistance are minimized in the individual unit cells in which the electrochemical reactions occur.

In a sealing structure of a sealing portion for maintaining the airtightness of a coolant passage in a separator for a fuel cell stack according to the present invention, a groove for a sealing member is formed by thinly coating the sealing member (adhesive) on a surface of one of two separators on which the coolant passage is formed. Moreover, dam portions are provided on a connection passage and the coolant passage to prevent the excessive sealing member from overflowing therefrom.

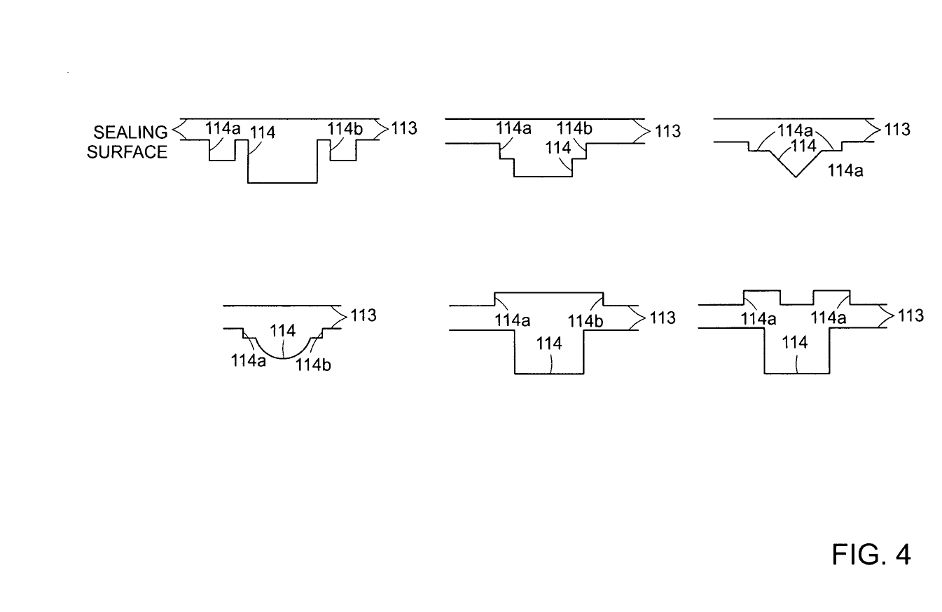

FIG. 4 is a cross-sectional view illustrating embodiments of a sealing structure of a fuel cell separator, in which various forms of the sealing structure are shown.

As shown in the figure, a groove 114, in which a sealing member, i.e., an adhesive is filled, is formed on a surface of one of the two separators 113 to be adhered to each other, i.e., on a surface where the coolant passage of a hydrogen electrode plate or an air electrode plate is formed.

In addition, dam portions 114a and 114b, in which the adhesive overflowing from the groove 114 is to be collected, are formed in the form of a groove on both sides of the groove 114.

That is, the dam portions 114a and 114b are additional spaces provided on both sides of the groove 114 to accommodate the adhesive overflowing from the groove 114 when the two separators 113 are pressurized to be adhered to each other. In order to additionally accommodate the adhesive overflowing from the groove 114, each of the two dam portions 114a and 114b may have one side open toward the boundary surface of the two separators 113 and the other side having a space either in communication with or separated from the groove 114.

Accordingly, the adhesive overflowing from the groove may be introduced into the dam portions 114a and 114b directly or via the sealing surface between the two separators 113.

In a preferred embodiment, as shown in FIG. 4, the dam portions 114a and 114b formed on both sides of the groove 114 may have a vertical surface with respect to the groove 114 to prevent the adhesive overflowing from the groove 114 from leaking to the outside. The vertical surface plays a role as a stopper for stopping flow of the adhesive filled in the dam portions 114a and 114b.

FIGS. 4A to 4F illustrate various embodiments of the present invention. FIG. 4A shows a structure in which the adhesive overflowing from the groove 114 flows along the sealing surface between the two separators 113 and is introduced into the dam portions 114a and 114b. The two dam portions 114a and 114b are formed on both sides of the groove 114 space apart from each other at a predetermined interval and the inside space thereof is separated from that of the groove 114.

In this case, the groove 114 and the dam portions 114a and 114b are formed on the same separator 113. The dam portions 114a and 114b, preferably, have a rectangular section.

FIGS. 4B to 4F show a structure in which the applied adhesive directly flows from the groove 114 into the dam portions 114a and 114b. One side of each of the dam portions 114a and 114b is open toward the groove 114 such that the inside space thereof is in communication with that of the groove 114 and each of the other side of the dam portions 114a and 114b has a vertical surface that can effectively prevent the flow of the adhesive.

In particular, FIGS. 4B to 4D show a structure in which the groove 114 and the dam portions 114a and 114b are formed on the same separator 113. Moreover, FIGS. 4E and 4F show a structure in which the groove 114 and the dam portions 114a and 114b are formed on different separators 113, respectively. That is, the groove 114 is formed on one separator 113 and the dam portions 114a and 114b are formed on the other separator 113.

In case of FIG. 4B, the dam portions 114a and 114b having a rectangular section are formed on both sides of the groove 114 having a rectangular section. In case of FIG. 4C, the dam portions 114a and 114b having a rectangular section are formed on both sides of the groove 114 having a triangular section. Moreover, in case of FIG. 4D, the dam portions 114a and 114b having a rectangular section are formed on both sides of the groove 114 having a semicircular section.

In case of FIG. 4E, the groove 114 having a rectangular section is formed on one separator 113 and the dam portions 114a and 114b having a rectangular section are formed on the other separator 113. In this case, the two dam portions are in communication with each other and the combined width of the two dam portions is greater than the width of the groove so as to provide a sufficient space for accommodating adhesive.

In particular, a part of the combined width of the dam portions 114a and 114b overlaps the inside width of the groove 114 and the other part of the width including the vertical surface serving as a stopping surface is positioned on both sides of the groove 114. The dam portions 114 a and 114b are in communication with the inside space of the groove 114.

In case of FIG. 4F, the groove having a rectangular section is formed on one separator 113 and the two dam portions 114a and 114b having a rectangular section are formed on the other separator 113. The dam portions 114a and 114b are spaced apart from each other at a predetermined interval. A part of the width of each of the dam portions 114a and 114b overlaps a part of the inside width of the groove 114, and the other part of the width including the vertical surface serving as a stopping surface is positioned on both sides of the groove 114. The dam portions 114 a and 114b are in communication with the inside space of the groove 114.

The above-described embodiments of FIG. 4 are provided solely for illustrating the invention and are not intended to limit the same. It should be noted that the present invention may be embodied with various changes, modification, alternatives and improvements, which may occur to those skilled in the art, without departing from the spirit and scope of the invention.

The dam portions in accordance with the present invention can prevent occurrence of sealing defect caused by excessive use of the adhesive. Moreover, in manufacturing a cooling separator by bonding two plates using slight excessive adhesive and pressurizing the bonding surface at a pressure of 1 bar, the adhesive is collected in the dam portions to form three sealing lines, thus improving the airtightness between the hydrogen and the coolant and between the air and the coolant manifold.

With the sealing structure as described above, it is possible to maintain a triple sealing effect against the coolant when an antifreeze/coolant based on ethylene glycol is used as a coolant for a fuel cell stack.

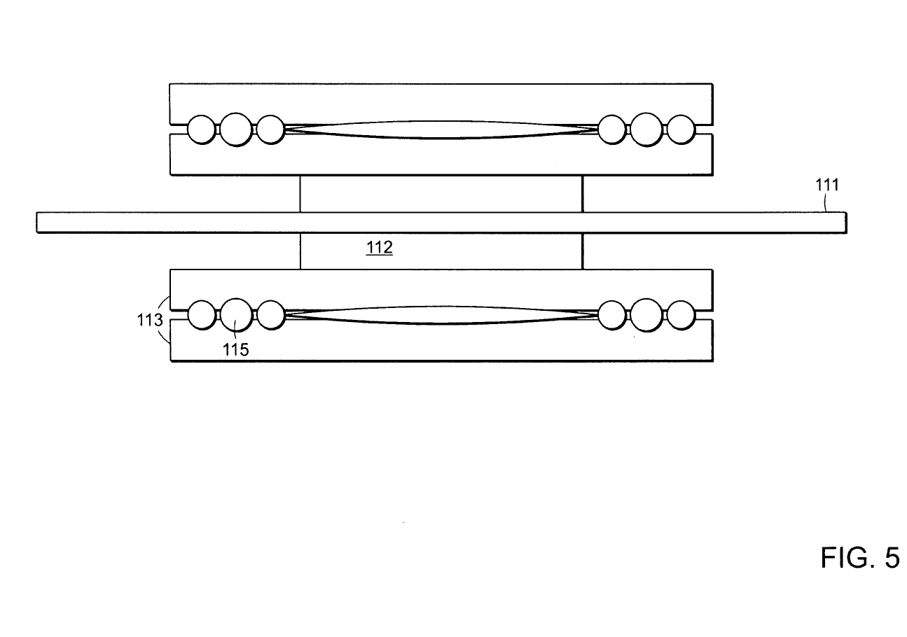

Moreover, as shown in FIG. 5, the sealing structure of the present invention is characterized in that, in order to provide an electrical conductivity in the vertical direction to a reaction area, which is a required characteristic of the fuel cell separator, a membrane electrode assembly (MEA) and a gas diffusion layer (GDL) are mounted between the separators 113 and the distance between two plates constituting the separator 113 is minimized by applying a predetermined pressure (generally 50 to 150 psi) required for the performance by the GLD formed of a porous material, thus preventing damage by the bonding pressure and deformation by repeated thermal fatigue. Moreover, it is possible to increase the contact region between the surface of the separator and the GDL by ensuring the airtightness of the sealing structure and the uniformity of the sealing structure using compression repulsive force of the two plates and further improve the electrical conductivity by reducing the electrical contact resistance.

FIG. 5 is a diagram illustrating the section of the fuel cell stack, in which reference numeral 111 denotes the MEA, 112 denotes the GDL, and 115 denotes the sealing member formed by an adhesive filled in the groove 114.

A process for manufacturing the separator with the above-described structure will be described below.

First, a hydrogen electrode plate and an air electrode plate are prepared. A groove 114 for an adhesive is formed on a surface of the hydrogen electrode plate, on which a coolant passage is formed, not on the air electrode plate.

Subsequently, dam portions 114a and 114b as shown in FIG. 4 are formed on either a bonding surface of the hydrogen electrode plate on which the groove 114 is formed or a bonding surface of the air electrode plate.

Then, an adhesive is applied in the middle of the hydrogen electrode plate. In this case, the adhesive may be GE plastic TSE322 which is an adhesive having no reactivity with an antifreeze/coolant.

Next, the hydrogen electrode plate and the air electrode plate are bonded to each other applying a pressure of 1 bar and then cured at 150° C. for about 30 to 60 minutes, preferably, for about 60 minutes. After the completion of the curing process, the applied pressure is removed.

As described above, according to the sealing structure of the fuel cell separator in accordance with the present invention, a groove in which an adhesive is filled is formed on a surface of one of two separators for maintaining the airtightness of a coolant passage, and a dam portion is formed on both sides of the groove to prevent the adhesive applied in the groove from overflowing into a connection passage and a coolant passage. Accordingly, the adhesive overflowing from the groove when the two separators are bonded to each other by applying a pressure is collected in the dam portions to form three sealing lines, thus improving the airtightness of the sealing portion. Moreover, it is possible to solve the problem that the performance of the fuel cell stack is deteriorated when an antifreeze/coolant leaks from the coolant passage to an MEA, in which the fuel cell reaction takes place, or the leaking coolant contaminates a catalyst of the MEA.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A sealing structure of a sealing portion for maintaining the airtightness of a coolant passage formed in a first and a second separators stacked in a fuel cell, wherein a groove in which an adhesive is to be filled is formed on sealing portion of the first separator, dam portions are formed on both sides of the groove, one side of each of the dam portions being open toward the boundary surface between the first and second separators such that adhesive, which is to overflow from the groove when the first and second separators are pressurized to be bonded to each other, may be filled in the respective dam portions.

2. The sealing structure of claim 1, wherein the dam portions are formed on the first separator, and one side of each of the dam portions is open toward the groove such that the inside space thereof is in communication with that of the groove.

3. The sealing structure of claim 1, wherein the dam portions are formed on the first separator, and the dam portions are formed on the boundary surface between the first and second separators so as to be spaced apart from the groove at a predetermined interval such that the inside space thereof is separated from that of the groove.

4. The sealing structure of claim 1, wherein the dam portions are formed on the second separator, the dam portions are in communication with each other to form a space to accommodate adhesive, the width of the dam portions is greater than the width of the groove, a part of combined width of the dam portions overlaps the width of the groove, and the other part of the width is positioned on both sides of the groove.

5. The sealing structure of claim 1, wherein the dam portions are formed on the second separator, the dam portions are spaced apart from each other at a predetermined interval, a part of the width of each of the dam portions overlaps a part of the width of the groove, and the other part of the width is positioned on both sides of the groove.
